(19) United States
(12) Patent Application Publication
(10) Pub. No.: US 2002/0085801 A1
(43) Pub. Date: Jul. 4, 2002

(54) Wavelength division multiplexing and de-multiplexing element and wavelength router

(75) Inventor: Hideaki Okayama, Tokyo (JP)

Correspondence Address: VENABLE, Post Office Box 34385, Washington, DC, 20043-9998, US

(73) Assignee: Oki Electric Industry Co., Ltd.

(21) Appl. No.: 09/895,404

(22) Filed: Jul. 2, 2001

(30) Foreign Application Priority Data
Dec. 28, 2000 (JP) 400846/2000

(51) Int. Cl. G02B 6/293

(52) U.S. Cl. 385/24

(57) ABSTRACT

The present invention has an object to provide a wavelength division demultiplexer having high wavelength dispersion properties using a fine photonic crystal. The wavelength router has a wavelength division demultiplexer for each of a plurality of input ports, and a wavelength division multiplexer for each of a plurality of output ports. The wavelength division demultiplexer and wavelength division multiplexer are formed of a phonotic crystal. The shapes of the entrance surface and exit surface of the photonic crystal are different. The second boundary of the wavelength division demultiplexer and first boundary of the wavelength division multiplexer are of a curved surface.

### BACKGROUND OF THE INVENTION

1. Field of the Invention The present invention relates to a wavelength division demultiplexer for transmitting a WDM optical signal input to the input port to a path differing per wavelength, and to a wavelength router employing such wavelength division demultiplexer.

2. Description of Related Art

Various types of wavelength division demultiplexer are conventionally known, such as an array waveguide diffraction grating element for example.

“Journal of Lightwave Technology, vol. 17, pp. 2032-2038, Nov. 1999” discloses the use of a photonic crystal showing super prism phenomenon as a wavelength division demultiplexer. A super prism phenomenon is a phenomenon where the change in the propagation direction of light against the change in wavelength is extremely large. A photonic crystal is arranged in a position similar to a crystal lattice such as a plate, column or globe having a large refractive index difference against the peripheral medium; that is, a substrate. A wavelength division demultiplexer with a large chromatic dispersion may be formed with this photonic crystal.

However, the following problems arise when a photonic crystal is used as the wavelength division demultiplexer to construct a wavelength router.

A wavelength router is required to respectively input optical signals separated per wavelength to separate waveguides (or optical fibers). As the wavelength dispersion property is insufficient with conventional wavelength division demultiplexers, it is necessary to maintain a relatively large spacing between the photonic crystal and the waveguide. This, however, will enlarge the wavelength router, and it would be preferable to sufficiently separate the optical signals of the respective wavelengths in the photonic crystal. In other words, upon employing the wavelength division demultiplexer described in the aforementioned reference in a wavelength router, a long photonic crystal is required for increasing the propagation distance of the optical signals in the photonic crystal forming the wavelength division demultiplexer.

However, with a photonic crystal, the distance equivalent to the so-called crystal lattice of the crystal has a fine structure less than the extent of an optical wavelength, and it is difficult to prepare a large photonic crystal. Further, it is not desirable to lengthen the photonic crystal as the light loss in the photonic crystal is relatively large.

In addition, depending on the system, it is necessary to selectively route the light from the plurality of input ports to each of the plurality of output ports. Conventionally, no system as described above employed the photonic crystal.

### SUMMARY OF THE INVENTION

Thus, an object of the present invention is to provide a small wavelength division multiplexing and de-multiplexing element with sufficient wavelength dispersion property.

Another object of the present invention is to provide a wavelength router employing this type of wavelength division multiplexing and de-multiplexing element as the wavelength division demultiplexer and wavelength division multiplexer.

The wavelength division multiplexing and de-multiplexing element according to the present invention is structured of a photonic crystal, the shape of the interface from which optical signals of this photonic crystal are output differs from the shape of the interface to which optical signals of the photonic crystal are entered, and the exit-side boundary is of a curved surface. This wavelength division multiplexing and de-multiplexing element is used as the wavelength division demultiplexer and wavelength division multiplexer.

With this construction, as the shape of the entrance-side boundary, which is the first refracting interface of the photonic crystal, is different from the exit-side boundary, which is the second refracting interface, it is possible to differ the propagation direction of optical signals that have passed through the photonic crystal for each wavelength. Moreover, an exit position of optical signals in the exit-side boundary differs for each wavelength. As the exit-side boundary is formed as a curved surface as described above, the direction of the normal of the exit-side boundary differs in accordance with its position in the plane. The wavelength dispersion property can therefore be improved as the direction of the normal of the exit-side boundary differs for each wavelength in the exit position of the optical signals.

Further, with the wavelength router of the present invention, each of a plurality of input ports respectively comprises a wavelength division demultiplexer, and each of a plurality of output ports comprises a wavelength division multiplexer. Such wavelength division demultiplexer and wavelength division multiplexer are respectively constituted from a photonic crystal.

According to this type of construction, realized is a system which routes optical signals from a plurality of input ports to a plurality of output ports for each wavelength by utilizing a photonic crystal element.

### BRIEF DESCRIPTION OF THE DRAWINGS

The foregoing and other objects, features and advantages of the present invention will be better understood from the following description taken in connection with the accompanying drawings, in which:

FIG. 1 is a diagram schematically showing the construction of the relevant parts of the wavelength router according to the first embodiment of the present invention;

FIG. 2 is a diagram for explaining the designing method of the second boundary of the wavelength division demultiplexer and the second boundary of the wavelength division multiplexer to be used in the wavelength router of the present invention;

FIG. 3 is a diagram schematically showing the construction of the relevant parts of the wavelength router according to the second embodiment of the present invention;

FIG. 4 is a diagram schematically showing the construction of the relevant parts of the wavelength router according to the third embodiment of the present invention;

FIG. 5 is a diagram showing the construction of the wavelength division multiplexing and de-multiplexing element of the present invention to be used in the wavelength router of the present invention; and

FIG. 6 is a diagram for explaining the wavelength router according to the fourth embodiment of the present invention.

### DESCRIPTION OF THE PREFERRED EMBODIMENTS

The embodiments of the present invention are now explained with reference to the drawings. The drawings, however, are merely for schematically showing the shape, size and positional relationship for understanding the invention. Thus, the present invention is not be limited to the illustrated examples.

First Embodiment

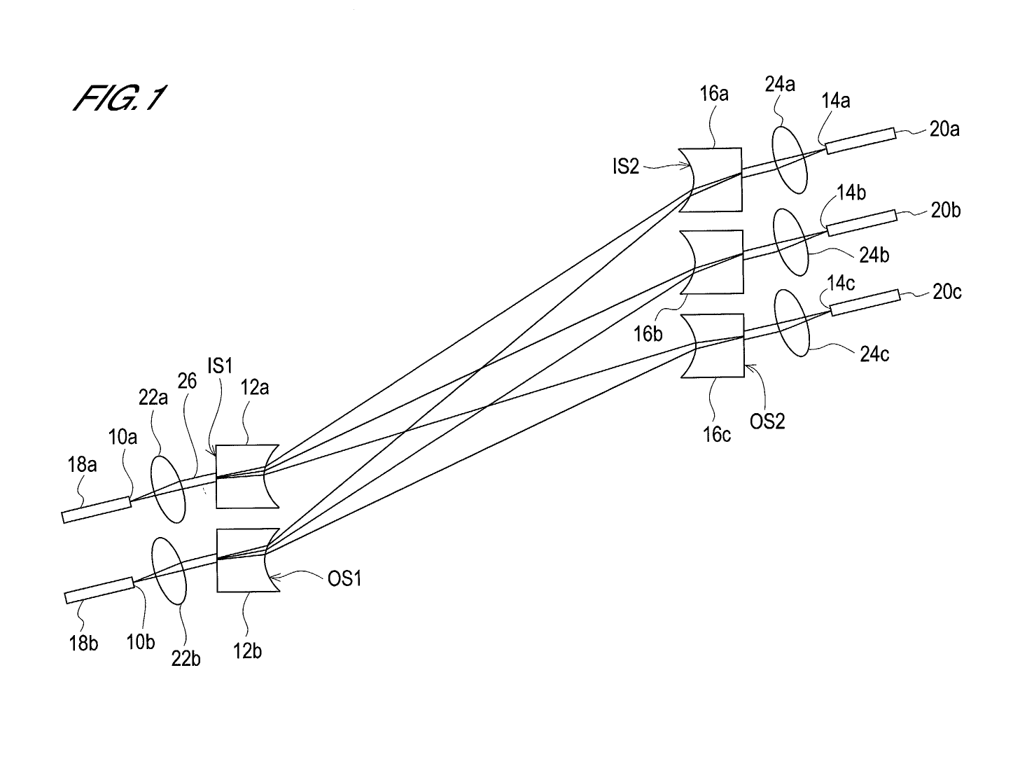

FIG. 1 is a diagram showing the construction of the relevant parts of a wavelength router of the first embodiment. This wavelength router comprises wavelength division demultiplexers 12a, 12b respectively for a plurality of (two for example) input ports 10a, 10b. This wavelength router also comprises wavelength division multiplexers 16a, 16b, 16c respectively for a plurality of (three for example) output ports 14a, 14b, 14c. This wavelength router is construced so as to transmit the WDM optical signals input to the input port to different output ports for each wavelength.

Output terminals of optical fibers 18a, 18b are respectively connected to the input ports 10a, 10b. Output terminals of optical fibers 20a, 20b, 20c are respectively connected to the output ports 14a, 14b, 14c.

Lenses 22a, 22b are respectively inserted between the input port 10a and wavelength division demultiplexer 12a, and between the input port 10b and wavelength division demultiplexer 12b. Moreover, lenses 24a, 24b, 24c are respectively inserted between the output port 14a and wavelength division multiplexer 16a, between the output port 14b and wavelength division multiplexer 16b, and between the output port 14c and wavelength division multiplexer 16c. These input-side lenses and output-side lenses construction a collimate system, and generate a light beam or flux with minimal loss between the input and output. Typically generated is a light beam or flux of parallel rays.

With the wavelength router of the present embodiment, the wavelength division multiplexing and de-multiplexing element is used as the wavelength division demultiplexer or the wavelength division multiplexer. Medium of the wavelength division multiplexing and de-multiplexing element, that is, the aforementioned wavelength division demultiplexers 12a, 12b and wavelength division multiplexers 16a, 16b, 16c, is photonic crystal. For example, this photonic crystal is of a medium having a high refractive index disposed in a hexagonal shape in a two-dimensional plane. However, it may also be of other crystal systems. The disposition of the medium having a high refractive index may also be of a one-dimensional structure. Moreover, it will be possible to control the shape of the light beam or flux by incorporating a plurality of crystal structures of a different shape into a single element.

The photonic crystal to be used requires a property where the dispersion of light changes largely depending on the direction. As the material for the photonic crystal, preferable examples are those in which air vents are arranged in a lattice shape on the Si plane waveguide, those in which semiconductor rods are arranged in a lattice shape in the dielectric layer, or artificial opal.

The wavelength router of the present embodiment has a construction wherein the optical system of the input side and output side are the same, or substantially the same. Nevertheless, with the input side and output side, the order of arrangement of the optical elements constituting the optical system is reversed. With the structural example shown in FIG. 1, as already described above, the number of input ports and the number of output ports differ, but such ports may be of the same number. It is preferable to arrange the optical elements of the input side and output side to be point symmetrical against the center of the optical system of the overall wavelength router.

With the wavelength router according to the present embodiment, a wavelength division multiplexing and de-multiplexing element formed of a photonic crystal, specifically a slab of photonic crystal, is provided as the wavelength division demultiplexer or the wavelength division multiplexer in a peripheral medium, which is preferably the air for this example. The interface or boundary between the photonic crystal and the peripheral medium forms the refracting interface or surface. Here, the first and second boundaries where optical signals enter to and exit from the photonic crystal are respectively referred to as the first and second refracting interfaces. Specifically, the first refracting interface corresponds to an optical signal inputting portion of the slab, and the second refracting interface to an optical signal outputting portion of the slab.

This wavelength router comprises first photonic crystals 12a, 12b on the entrance side of this router and second photonic crystals 16a, 16b, 16c on the exit side of the router. The first refracting interface of the respective first photonic crystals is representatively referred to as IS1, and the second refracting interface is representatively referred to as OS1. Similarly, the first refracting interface of the respective second photonic crystals is representatively referred to as OS2, and the second refracting interface is representatively referred to as IS2.

With this wavelength router, the shapes of the photonic crystal to be used; that is, the first refracting interface and the second refracting interface, are different. If the surface construction is such that the optical signals to the wavelength division multiplexing and de-multiplexing element may be output for each wavelength and while being sufficiently separated, both refracting interfaces maybe a combination of any surface shape. In the illustrative structural example, when the wavelength division multiplexing and de-multiplexing element is to be used as the wavelength division demultiplexer, the first refracting interface IS1, which is the surface of the wavelength division demultiplexers 12a, 12b for entering optical signals, is of a planar surface, and the second refracting interface OS1, which is the surface for exiting optical signals, is of a concave curved surface. Meanwhile, when the wavelength division multiplexing and de-multiplexing element is to be used as the wavelength division multiplexer, the second refracting interface IS2, which is the surface of the wavelength division multiplexers 16a, 16b, 16c for entering optical signals, is of a concave curved surface, and the first refracting interface OS2, which is the surface for exiting optical signals, is of a planar surface. As described later, according to this construction, the wavelength dispersion property becomes better than conventional constructions by at least one digit.

Further, the shape of these refracting surfaces may be a combination of faces in a variety of shapes. For instance, a combination of a planar surface with a convex surface or a concave surface, a combination of a concave surface and a concave surface, or a combination of a convex surface and a convex surface. The curvature radius of the respective curved surfaces may be the same or different. As such curved surface, it is preferable to make it from a partial surface of a cylindrical surface, oval surface, parabolic surface, or rotational surface of a secondary to high-order curved surface.

Specifically, a wavelength division multiplexing and de-multiplexing element comprises a slab of photonic crystal. The optical signal inputting portion of the slab has one of a planer surface or a convex surface. The optical signal outputting portion of the slab has other of a planer surface or a convex surface.

The basic operation of the wavelength router of the present embodiment is now explained with reference to FIG. 1. WDM optical signals guided to the input port 10a by the optical fiber 18a is made into input light 26 of a light beam or flux in an appropriate shape by the lens 22a. Thereafter, this input light 26 is input to the wavelength division demultiplexer 12a. In the photonic crystal forming the wavelength division demultiplexer 12a, the propagation direction of the light differs depending on the wavelength. Light signals that output the wavelength division demultiplexer 12a are also maintained in a state where the propagation direction thereof is different for each wavelength. Optical signals of different wavelengths are respectively input to different wavelength division multiplexers 16a, 16b, 16c, respectively. Thereafter, the optical signals of the respective wavelengths pass through the respective wavelength division multiplexers, and are guided to the corresponding lenses 24a, 24b, 24c. Next, the optical signals of the respective wavelengths are condensed at the end face of the optical fibers 20a, 20b, 20c connected to the corresponding output ports 14a, 14b, 14c.

As described above, the photonic crystal forming the wavelength division demultiplexer and wavelength division multiplexer is used for the purpose of changing the propagation direction of light for each wavelength. Therefore, with respect to the size of the photonic crystal itself, so as long as a width of the crystal is as small as several times that of the light flux, such size would suffice as it will not pass the end of the second refracting interface (second boundary) from which the light flux propagated in the crystal exits. Specifically, the dimension of the slab of the photonic crystal is two to three times a spot diameter of the inputting optical signal.

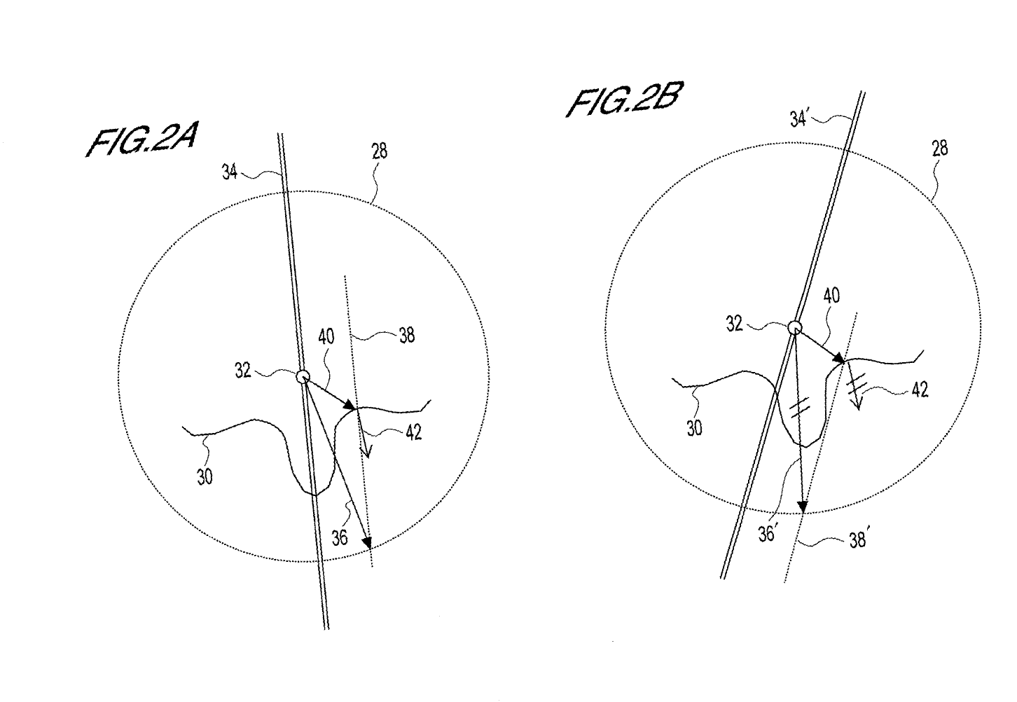

Next, a designing method of the second refracting interface (second boundary) OS1 of the wavelength division demultiplexers 12a, 12b and the second refracting interface (second boundary) IS2 of the wavelength division multiplexers 16a, 16b, 16c will be explained with reference to FIG. 2. Basically, these surfaces may be of the same shape. FIG. 2 is a diagram showing the state of light propagation between the wave number vector space.

FIGS. 2A and 2B illustrate dispersion surfaces 28 and 30. The dispersion surface 28 is a surface which plotted the size of the optical wave number vectors in the free space outside the photonic crystal to the respective vector directions. With the dispersion surface 28, the distance from the origin 32 shows the size of the wave number vector of the input optical signal 26. The dispersion surface 30 is a surface which plotted the size of the optical wave number vectors in the photonic crystal (wavelength division demultiplexer 12a) to the respective vector directions. As shown in the drawings, it is of a complex structure reflecting the symmetric property of the crystal structure. The aforementioned origin 32 is the common starting point of the vectors for comparing the size of the optical wave number vectors. Therefore, the distance from the starting point of the dispersion surface 30 shows the size of the wave number vector of the input optical signal 26 in the photonic crystal. As the dispersion surface 30 is of a structure where the direction of the normal of the dispersion surface 30 changes suddenly, a slight change in the wavelength is converted into a sudden change in the propagation direction.

FIGS. 2A and 2B show a part of the direction of the dispersion surface 30. Here, the optical wavelength becomes the wavelength of the transparent area outside the band gap.

An explanation is foremost made with reference to FIG. 2A. In FIG. 2A, the straight line which passes through the origin 32 and extends in the upward and downward directions in the drawing represents the vector component (hereinafter referred to as “normal vector 34”) perpendicular to the first refracting interface (first boundary) of the photonic crystal (wavelength division demultiplexer 12a). The wave number vector 36, with the origin 32 as the starting point and the dispersion surface 28 as the terminal, is the wave number vector of the input optical signal 26 entering the first refracting interface of the photonic crystal. The angle formed by the normal vector 34 and wave number crystal 36 corresponds to the incident angle to the first refracting interface of the input optical signal 26.

Moreover, at the interface of the two mediums of free space and photonic crystal, the connective components of light propagating in the respective mediums will be the same. Thus, the wave number vector of the optical signals in the photonic crystal is represented with the wave number vector 40 with the origin 32 as the starting point, and the intersection of the vector 38 parallel to the normal vector 34 and the dispersion surface 30 as the terminal. The energy propagation direction (light beam direction) of the optical signals represented by this wave number vector 40 is known to be the normal direction 42 of the dispersion surface 30 in the terminal of the wave number vector 40. Therefore, the propagation direction of the optical signals in the photonic crystal becomes the direction shown with the arrow 42 in FIG. 2A.

The size of the aforementioned wave number vector 40 differs in accordance with the wavelength of the optical signals. Therefore, the intersection of the vector 38 and the dispersion surface 30 moves in accordance with the wavelength. As described above, the normal direction 42 of the dispersion surface 30 suddenly changes in accordance with its position on the dispersion surface 30, and a slight difference in the wavelength results in a large difference in the propagation direction of the optical signals.

Nevertheless, when the second refracting interface (second boundary) OS1 and the first refracting interface (first boundary) of the photonic crystal (wavelength division demultiplexer 12a) are parallel, the wave number vector 40 is converted into the same vector as with the wave number vector 36 of the originally input optical signals. Therefore, in this case, the optical signals output from the photonic crystal will be of the same propagation direction even with different wavelengths. Moreover, even when the second refracting interface OS1 is not parallel with the first refracting interface (first boundary) and is inclined with respect to the first refracting interface, the output optical signals will be parallel rays if the second refracting interface OS1 is of a planar surface, and the difference in the propagation direction in accordance with the wavelength will be eliminated. Thus, a design as shown in FIG. 2B becomes necessary.

In FIG. 2B, the straight line passing through the origin 32 and inclining from the upward and downward directions represents the vector component (hereinafter referred to as “normal vector 34′”) perpendicular to the second refracting interface OS1 of the photonic crystal (wavelength division demultiplexer 12a). In FIG. 2B, a normal vector 34′ in a single point on the second refracting interface OS1 is only shown. Thereby, the wave number vector 36′ of the optical signals output from the second refracting interface OS1 becomes a wave number vector with the starting point being the origin 32, and the terminal being the intersection of the vector 38′ parallel to the normal vector 34′ and the dispersion surface 28. By selecting a direction of the normal vector 34′, the wave number vector 36′ of the output optical signals will become parallel with the normal direction (propagation direction) 42. As described above, since the propagation direction of the optical signals; in other words, the normal direction 42 of the dispersion surface 30, differs in accordance with the wavelength, it is possible to obtain output optical signals having different propagation directions for each wavelength by differing inclination of the normal vector 34′ for each wavelength. The shape of the second refracting interface OS1 obtained as a result of the above is of a curved surface.

According to the wavelength division multiplexing and de-multiplexing element of the present embodiment, it is possible to obtain a wavelength dispersion of approximately 50° to a 1% wavelength change of Δλ with a fine size several times a light flux.

The shape of the photonic crystals (wavelength division multiplexers) 16a, 16b, 16c on the output side may be of the same shape as the photonic crystals (wavelength division demultiplexers) 12a, 12b on the input side. With the photonic crystal on the output side, a process opposite to the process arising in the photonic crystal on the input side is conducted.

According to the structure described above, realized may be a wavelength router with a plurality of input and output ports even with a fine photonic crystal. The simplification of preparation and reduction of light loss may be expected from this structure.

Second Embodiment

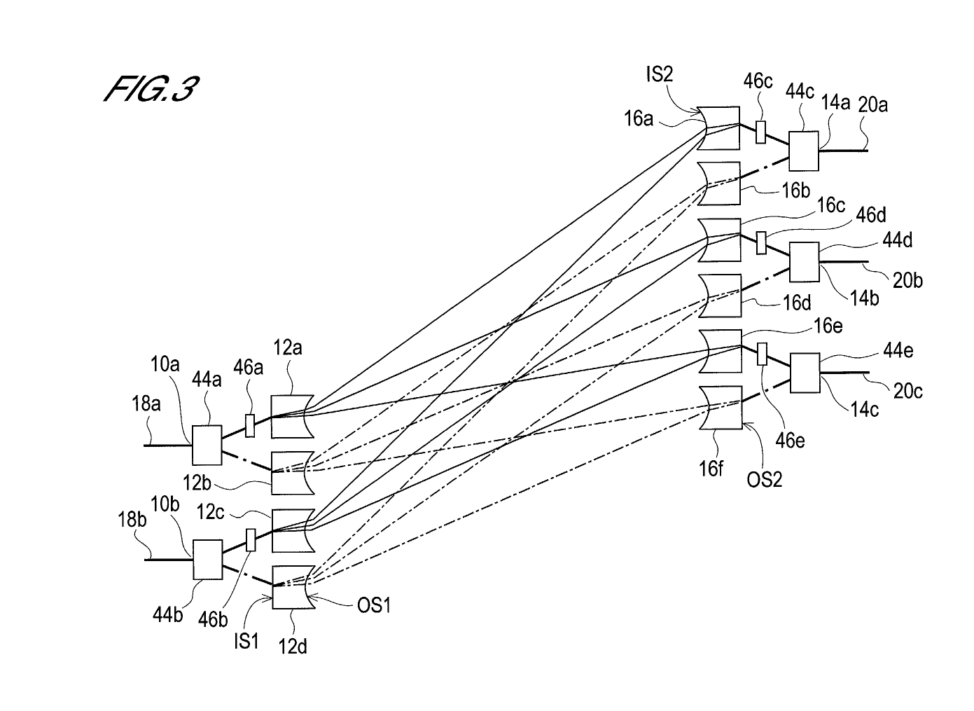

FIG. 3 is a diagram showing the structure of relevant parts of the wavelength router of the second embodiment. The wavelength router according to this embodiment has a constitutional feature that a polarization beam splitter and polarization beam rotator are provided to at least the input port or the output port.

The wavelength router of this embodiment comprises wavelength division demultiplexers 12a, 12b, 12c, 12d for each of the plurality of input ports 10a, 10b. This wavelength router also comprises wavelength division multiplexers 16a, 16b, 16c, 16d, 16e for a plurality of output ports 14a, 14b, 14c, respectively. These wavelength division demultiplexers and wavelength division multiplexers have the same structure as those described in the first embodiment.

Output terminals of optical fibers 18a, 18b are respectively connected to the input ports 10a, 10b. And output terminals of optical fibers 20a, 20b, 20c are respectively connected to the output ports 14a, 14b, 14c.

Polarization beam splitter 44a and polarization beam rotator 46a are inserted between the input port 10a and wavelength division demultiplexer 12a. And polarization beam splitter 44b and polarization beam rotator 46b are inserted between the input port 10b and wavelength division demultiplexer 12c.

Further, polarization beam splitter 44c and polarization beam rotator 46c are inserted between the output port 14a and wavelength division multiplexer 16a. Polarization beam splitter 44d and polarization beam rotator 46d are inserted between the output port 14b and wavelength division multiplexer 16c, and polarization beam splitter 44e and polarization beam rotator 46e are inserted between the output port 14c and wavelength division multiplexer 16e.

Polarization beam splitters 44a and 44b are for splitting the input light into mutually crossing two polarization components. Further, polarization beam rotators 46a to 46e are for rotating the input polarized light 90°. The polarization beam splitters 44c, 44d and 44e are of the same structure as the polarization beam splitters 44a and 44b. The polarization beam splitters are structured such that mutually crossing two polarized light are entered therein, and such polarized light are multiplexed in the polarization beam splitter. The polarization beam rotators 46c, 46d and 46e on the output side are for returning the polarized light which was polarized and rotated by the polarization beam rotators 46a and 46b on the input side to the original polarized light. A dielectric multi-layer film, birefringent crystal, or photonic crystal may be used as the polarized beam splitter. A half-wave plate or a faraday rotating element may be used as the polarization beam rotator.

As shown in the example of FIG. 3, the input light from the input port 10a is split into two polarized light by the polarization beam splitter 44a. One of the polarized light passes through the polarization beam rotator 46a and polarized and rotated, and thereafter input to the wavelength division demultiplexer 12a. The other polarized light is directly input to the wavelength division demultiplexer 12b.

Similarly, the input light from the input port 10b is split into two polarized light with the polarization beam splitter 44b. One of the polarized light passes through the polarization beam rotator 46b and polarized and rotated, and thereafter input to the wavelength division demultiplexer 12c. The other polarized light is directly input to the wavelength division demultiplexer 12d.

Further, the polarized light that is polarized and rotated on the input side is input to the wavelength division multiplexer on the output side to which the polarization beam splitter and polarization beam rotator are disposed. The polozarized light that is not polarized and rotated on the input side is input to the wavelength division multiplexer to which the polarization beam splitter and polarization beam rotator are not disposed.

As shown with the example in FIG. 3, the polarized light that has entered the wavelength division multiplexer 16a is output to the output port 14a after passing through the polarization beam rotator 46c and polarization beam splitter 44c. Moreover, the polarized light that has entered the wavelength division multiplexer 16b is output to the output port 14a after passing through the polarization beam splitter 44c. Further, the polarized light that has entered the wavelength division multiplexer 16c is output to the output port 14b after passing through the polarization beam rotator 46d and polarization beam splitter 44d. Moreover, the polarized light that has entered the wavelength division multiplexer 16d is output to the output port 14b after passing through the polarization beam splitter 44d. Further, the polarized light that has entered the wavelength division multiplexer 16e is output to the output port 14c after passing through the polarization beam rotator 46e and polarization beam splitter 44e. Moreover, the polarized light that has entered the wavelength division multiplexer 16f is output to the output port 14c after passing through the polarization beam splitter 44e.

With this construction, realized is a wavelength router that does not depend on polarization. Generally, a photonic crystal has strong dependency on polarization. Moreover, polarization in an optical fiber is unpredictable. Therefore, upon employing a photonic crystal in an optical communications system, it is preferable to make the photonic crystal of a structure which does not depend on polarization as described in the present embodiment.

Third Embodiment

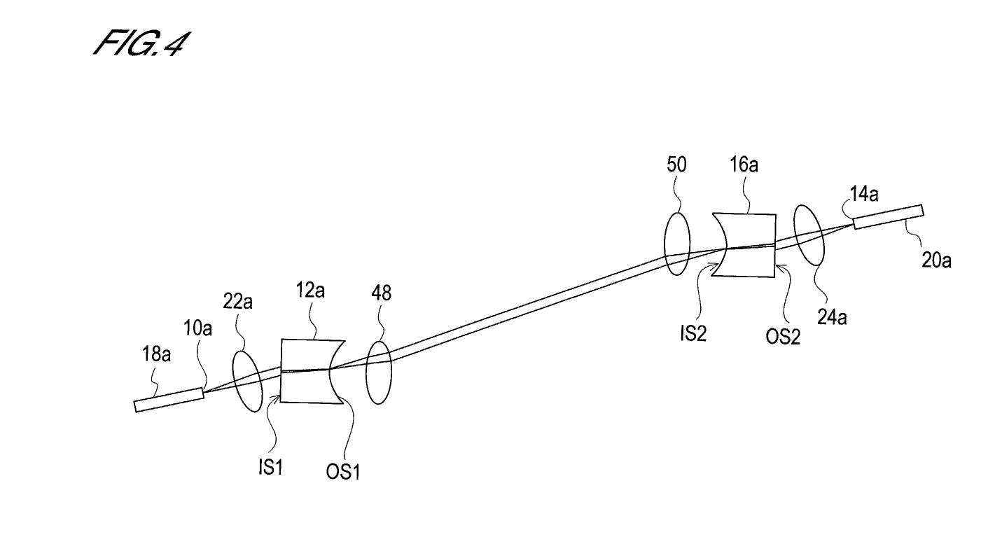

FIG. 4 is a diagram showing the construction of main parts of a wavelength router according to the third embodiment. The wavelength router of this embodiment has a consitutional feature that collimate lenses are respectively provided on the second refracting interface (second boundary) from which the light from the wavelength division demultiplexer is output, and on the second refracting interface (second boundary) to which the light from the wavelength division multiplexer is input.

The wavelength router of this embodiment is basically of the same construction as that of the first embodiment described above. In the example shown in FIG. 4, however, a lens 48 is additionally inserted into the second refracting interface OS1 side of the wavelength division demultiplexer 12a. Moreover, a lens 50 is inserted into the second refracting interface IS2 side of the wavelength division multiplexer 16a. These lenses 48 and 50 constitute the collimate system. Therefore, light output from the second refracting interface OS1 of the wavelength division demultiplexer 12a is made into parallel beams by the lens 48, and thereafter condensed against the second refracting interface IS2 of the wavelength division multiplexer 16a by the lens 50. With this construction, the light loss between the wavelength division demultiplexer and wavelength division multiplexer can be reduced.

Fourth Embodiment

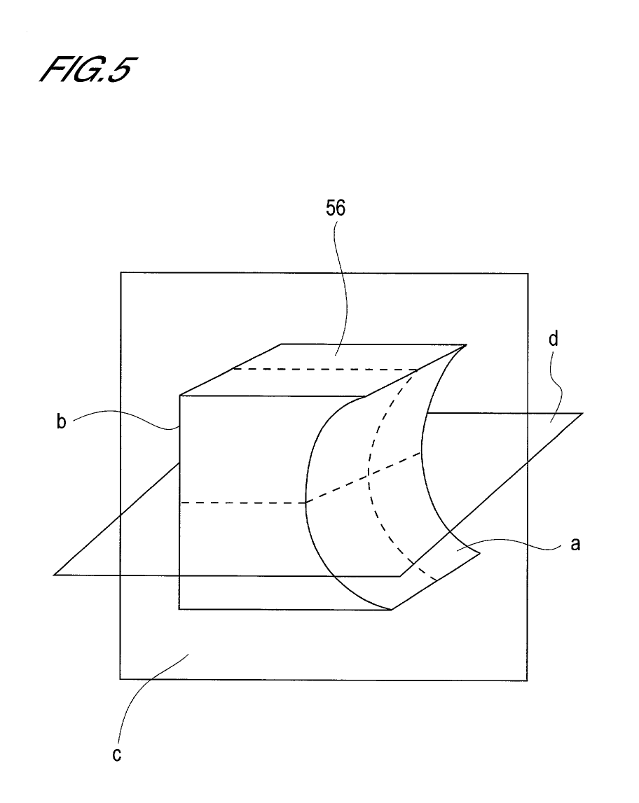

FIG. 5 is a perspective view showing the construction of the wavelength division multiplexing and de-multiplexing element to be used as the wavelength division demultiplexer or wavelength division multiplexer. As shown in FIG. 5, the shape of the photonic crystal 56 forming the wavelength division multiplexing and de-multiplexing element is of a shape wherein one surface a of hexahedron is rounded toward the surface b opposing such face a. The cross section shape of the cut surface upon cutting such hexahedron at the planar surface c perpendicularly crossing the surface b is of a shape where one side of a rectangle is rounded. Moreover, the cross section shape of the cut surface upon cutting such hexahedron at the planar surface d perpendicular to the surface c is a rectangle.

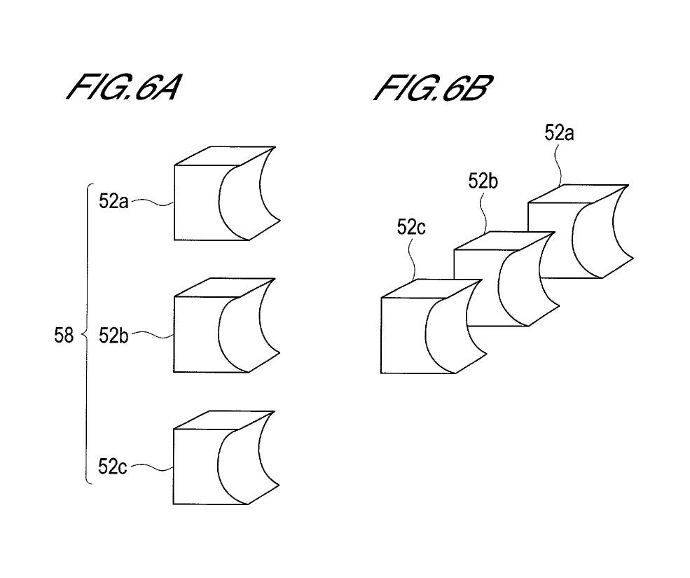

FIG. 6 is a perspective view for illustrating a wavelength router of the fourth embodiment in which the wavelength division multiplexing and de-multiplexing element is employed as the wavelength division demultiplexer. As shown in FIG. 6, the shapes of the photonic crystal forming the respective wavelength division demultiplexers 52a, 52b, 52c are the same as described in reference to FIG. 5.

FIG. 6A shows a wavelength division demultiplexer group 58 formed by arranging a plurality of wavelength division demultiplexers. The method of arranging the wavelength division demultiplexers 52a, 52b, 52c constituting this wavelength division demultiplexer group 58 is the same as the one employed in the first, second and third embodiments. In other words, as shown in FIG. 6A, the wavelength division demultiplexers 52a, 52b, 52c are arranged such that the surfaces corresponding to the surface d described with reference to FIG. 5 become parallel with one another.

Meanwhile, as shown in FIG. 6B, the wavelength division demultiplexers 52a, 52b, 52c may also be arranged such that the surfaces corresponding to the surface c described with reference to FIG. 5 become parallel with one another. The arrangement shown in FIG. 6B is preferable from the perspective of miniaturization of the device. This is particularly effective for the structure shown in FIG. 3.

The method of arrangement described above may also be adopted in a case where a wavelength division multiplexing and de-multiplexing element is used as a wavelength division multiplexer.

What is claimed is:

1. A wavelength division multiplexing and demultiplexing element comprising:
a slab of photonic crystal;
an optical signal inputting portion of the slab having one of a planer surface or a convex surface; and
an optical signal outputting portion of the slab having other of a planer surface or a convex surface.

2. A wavelength division multiplexing and de-multiplexing element according to claim 1, wherein the element serves as a wavelength division de-multiplexer, the optical signal inputting portion has the planer surface, and the optical signal outputting portion has the convex surface.

3. A wavelength division multiplexing and de-multiplexing element according to claim 1, wherein the element serves as a wavelength division multiplexer, the optical signal inputting portion has the convex surface, and the optical signal outputting portion has the planer surface.

4. A wavelength division multiplexing and de-multiplexing element according to claim 1, wherein a dimension of the slab is two to three times a spot diameter of the inputting optical signal.

5. A wavelength router comprising:
a wavelength division de-multiplexer having a first slab of photonic crystal, an optical signal inputting portion of the first slab having a planer surface, and an optical signal outputting portion of the first slab having other of a convex surface; and
a wavelength division multiplexer having a second slab of photonic crystal, an optical signal inputting portion of the second slab having a convex surface, and an optical signal outputting portion of the second slab having a planer surface.

6. A wavelength router according to claim 5, wherein each dimension of the first and second slabs is two to three times a spot diameter of the each inputting optical signal.

7. A wavelength router comprising wavelength division demultiplexers separately provided for each of a plurality of input ports and wavelength division multiplexers separately provided for each of a plurality of output ports, and which transmits WDM optical signals from said input ports to respective output ports differing for each wavelength, after sequentially passing through said wavelength division demultiplexer and wavelength division multiplexer,
wherein the medium of said wavelength division multiplexer and wavelength division demultiplexer is a photonic crystal.

8. A wavelength router according to claim 7, wherein, in said wavelength division multiplexer and wavelength division demultiplexer, the shape of the first refracting interface of said medium differs from the shape of the second refracting interface of said medium, and said second refracting interface is a curved surface.

9. A wavelength router according to claim 8, wherein the first refracting interface of said medium of said wavelength division demultiplexer is a surface to which said optical signals are input, and said second refracting interface of said wavelength division demultiplexer is a surface from which de-multiplexed optical signals are output.

10. A wavelength router according to claim 8, wherein the second refracting interface of said medium of said wavelength division multiplexer is a surface to which said optical signals transmitted from said wavelength division demultiplexer are input, and said second refracting interface of said wavelength division multiplexer is a surface from which the multiplexed optical signals of the same wavelength are output.

11. A wavelength router according to claim 8, wherein said first refracting interface is a planar surface.

12. A wavelength router according to claim 7, wherein, in said wavelength division demultiplexer and wavelength division multiplexer, said first and second refracting interfaces of said medium are respectively a planar surface and a curved surface;
the first refracting interface of said medium of said wavelength division demultiplexer is a surface to which optical signals are input, and said second refracting interface of said wavelength division demultiplexer is a surface from which de-multiplexed optical signals are output;
the second refracting interface of said medium of said wavelength division multiplexer is a surface to which said optical signals transmitted from said wavelength division demultiplexer are input, and said second refracting interface of said wavelength division multiplexer is a surface from which the multiplexed optical signals of the same wavelength are output;
a first collimate lens is respectively disposed between said input ports and said wavelength division demultiplexers; and
a second collimate lens is respectively disposed between said wavelength division multiplexers and said output ports.

13. A wavelength router according to claim 7, wherein each of said input port is provided with a couple of said wavelength demultiplexers as first and second wavelength division demultiplexers;
each of said output ports is provided with a couple of said wavelength multiplexers as first and second wavelength division multiplexers;
said first and second refracting interfaces of said medium are respectively a planar surface and a curved surface in said wavelength division demultiplexer and wavelength division multiplexer;
said first refracting interface of said medium of said wavelength division demultiplexer is a surface to which optical signals are input, and said second refracting interface of said wavelength division demultiplexer is a surface from which de-multiplexed optical signals are output;
said second refracting interface of said medium of said wavelength division multiplexer is a surface to which said optical signals transmitted from said wavelength division demultiplexer are input, and said second refracting interface of said wavelength division multiplexer is a surface from which the multiplexed optical signals of the same wavelength are output;
a polarization beam splitter and polarization beam rotator are respectively interposed in this order between said input ports and said first wavelength division demultiplexer;
said polarization beam splitter is respectively interposed as a common element between said input ports and said second wavelength division demultiplexer;
a polarization beam rotator and polarization beam splitter are respectively interposed in this order between said first wavelength division multiplexer and said output ports; and
said polarization beam splitter is respectively interposed as a common element between said second wavelength division multiplexers and said output ports.

14. A wavelength router according to claim 7, further comprising a collimate lens system for making the optical signals between said wavelength division demultiplexer and wavelength division multiplexer into parallel beams.
